(19) United States
(12) Patent Application Publication
(10) Pub. No.: US 2005/0270554 A1
(43) Pub. Date: Dec. 8, 2005

(54) Print control apparatus, print system, and print control method

(75) Inventor: Takeshi Aoki, Nagoni (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/135,641

(22) Filed: May 24, 2005

(30) Foreign Application Priority Data
May 24, 2004 (JP) P2004-153180

(51) Int. Cl. G06F 15/00

(52) U.S. Cl. 358/1.13

(57) ABSTRACT

A print control apparatus selects a print control sequence in response to printer setup information acquired from a printer connected to the print control apparatus and executes the selected print control sequence, and selects and executes the print control sequence corresponding to temporary printer setup information if the print control apparatus accepts a print request before the printer setup information is acquired from the printer.

### BACKGROUND OF THE INVENTION

This invention relates to a print control apparatus for controlling the print operation of a printer and in particular to a suitable art when the print control apparatus includes a scanner function.

As a general configuration of a print system, a configuration wherein a print control apparatus (apparatus for transmitting print data, various commands, etc., and controlling the print operation) is used in combination with a printer is known. (Refer to JP-A-11-4367)

In such a system, if the printer is designed so that it can be changed with respect to predetermined parameters, members, etc., the print control apparatus needs to keep track of the state of the parameters, etc., which will be hereinafter referred to as “printer setup information,” and then generate print data in response to the printer setup information. For example, if the printer allows the user to select a predetermined ink type from among ink types for setting ink, the available print paper types are limited depending on the ink type and further the suitable resolution, image processing parameters, used LUT (Look-Up Table), and the like when print data is generated change depending on the print paper type.

Hitherto, if the printer setup information is changed, it has been a common practice for the user to enter the change in the print control apparatus and for the print control apparatus to generate print data in response to the entered change.

If the print control apparatus can automatically acquire the printer setup information from the printer, the need for the user to enter the change each time is eliminated and the burden on the entry can be largely reduced.

However, when power is turned on (or the printer is reset), usually the printer first executes predetermined initialization processing (preparation processing for placing the printer in an executable state of print operation), such as error check of ink cartridges, etc., for example. Thus, if the print control apparatus generates print data in response to the change automatically acquired from the printer, the print control apparatus cannot acquire the change to generate print data until completion of the initialization processing of the printer, and the print operation cannot promptly be started; this is a problem.

### SUMMARY OF THE INVENTION

It is therefore an object of the invention to promptly start print operation while reducing the burden on the entry of the user if printer setup information is changed in a print system wherein a print control apparatus is used in combination with a printer.

In order to solve the aforesaid object, the invention is characterized by having the following arrangement.

(1) A method of controlling a print control apparatus which selects a print control sequence in response to printer setup information acquired from a printer connected to the print control apparatus and executes the selected print control sequence, the method comprising:
if the print control apparatus accepts a print request before the printer setup information is acquired from the printer, selecting and executing the print control sequence corresponding to temporary printer setup information.

(2) The method according to (1) further comprising:
acquiring the printer setup information from the printer before the corresponding print control sequence is completed; and
completing the print control sequence corresponding to the temporary printer setup information if the temporary printer setup information matches the printer setup information acquired from the printer.

(3) The method according to (1) further comprising stopping the print control sequence corresponding to the temporary printer setup information if the temporary printer setup information does not matches the printer setup information acquired from the printer.

(4) The method according to (3) further comprising executing a print control sequence corresponding to the printer setup information acquired from the printer if the temporary printer setup information does not match the printer setup information acquired from the printer.

(5) The method according to (1) further comprising executing one of processing of executing a print control sequence corresponding to the printer setup information acquired from the printer and processing of promoting a user to change a printer parameter so as to fit to the temporary printer setup information if the temporary printer setup information does not match the printer setup information acquired from the printer.

(6) A print control apparatus which selects a print control sequence in response to printer setup information acquired from a printer connected to the print control apparatus and executes the selected print control sequence, and selects and executes the print control sequence corresponding to temporary printer setup information if the print control apparatus accepts a print request before the printer setup information is acquired from the printer.

(7) The print control apparatus according to (6), wherein
the printer setup information is acquired from the printer before the corresponding print control sequence is completed; and
the print control sequence corresponding to the temporary printer setup information is completed if the temporary printer setup information matches the printer setup information acquired from the printer.

(8) The print control apparatus according to (6), wherein the print control sequence corresponding to the temporary printer setup information is stopped if the temporary printer setup information does not matches the printer setup information acquired from the printer.

(9) The print control apparatus according to (6), wherein the printer setup information includes information of ink set in the printer.

(10) The print control apparatus according to (6), wherein the print control apparatus comprises a scanner function and the print control sequence includes scan processing.

(11) The print control apparatus according to (6), wherein the print control sequence includes at least any process of menus screen presentation, user entry acceptance, image read, image processing, print data generation, or print data transmission.

(12) The print control apparatus according to claim 6, wherein one of processing of executing the print control sequence corresponding to the acquired printer setup information and processing of prompting a user to change a printer parameter so as to fit to the temporary printer setup information is executed if the temporary printer setup information does not match the printer setup information acquired from the printer.

(13) The print control apparatus according to claim 6, wherein the print control apparatus includes a display unit that displays a screen showing an image processing information concerning the temporary printer setup information before acquiring the printer setup information from the printer, and an image processing unit that executes image processing using the image processing information concerning the temporary printer setup information when accepting a print start command which employs the image processing information concerning the temporary printer setup information.

(14) A print system comprising:
a print control apparatus according to claim 6; and
a printer that executes printing based on a print data transmitted from the print control apparatus,
wherein the printer executes a predetermined initialization processing when the printer is turned on or the printer is reset, and sends the printer setup information after completing the initialization processing.

(15) The print system according to claim (14), wherein the printer stores the printer setup information.

The print control method of the invention can be carried out by the CPU included in the print control apparatus. A computer program for the purpose can be installed in or loaded into the print control apparatus through any of various media such as a CD-ROM, a magnetic disk, semiconductor memory, or a communication network.

The invention makes it possible to promptly start the print operation while reducing the burden on the entry of the user if the printer setup information is changed in the print system wherein the print control apparatus is used in combination with the printer.

### BRIEF DESCRIPTION OF THE DRAWINGS

FIG. 1 is an external view of a print system 1 in an embodiment of the invention;

FIG. 2 is a block diagram to show the hardware configuration of the print system 1 in the embodiment of the invention;

FIG. 3 is a drawing to show an example of the correspondence between printer setup information and print control sequence; and

FIG. 4 is a flowchart to show print control processing of a scanner 10.

### DETAILED DESCRIPTION OF PREFERRED EMBODIMENTS

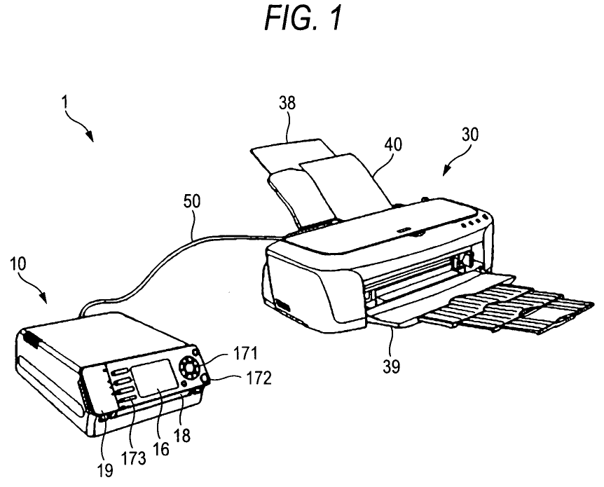

The best mode for carrying out the invention will be discussed. FIG. 1 shows the appearance of a print system 1 in an embodiment of the invention. As shown in FIG. 1, the print system 1 is made up of a scanner 10 and a printer 30, which are connected by a cable 50. However, they may be connected through a communication network (LAN, Internet, leased line, packet communication network, combination thereof, or the like, wired or wireless).

The scanner 10 has a scanner function of optically scanning an original of a photo, a document, a drawing, a film, etc., and acquiring the image data to be printed. The scanner 10 further includes a function of generating print data based on the acquired image data and transmitting the print data together with a print command, etc., to the printer 30 and also operates as a print control apparatus of the printer 30.

As shown in FIG. 1, the scanner 10 has a liquid crystal panel 16, a cross button 171, an OK button 172, selection buttons 173, a holder insertion slot 18, a door 19, a card slot (not shown), etc.

A menu screen for making various settings is displayed on the liquid crystal panel 16. The cross button 171 is a button for selecting an item in the menu screen displayed on the liquid crystal panel 16. The OK button 172 is a button for confirming the item selected with the cross button 171. The selection buttons 173 include a plurality of buttons, such as a button for making an additional print of an image and a button for saving the read image on a memory card.

The holder insertion slot 18 is an insertion slot for inserting a holder for placing a negative film, a photo, etc., into the scanner 10. As the holder is inserted through the holder insertion slot 18, the film, etc., placed on the holder is scanned and the image data is input into the scanner 10.

The door 19 is attached to the scanner 10 so that it can be opened and closed. When the door 19 is opened, the card slot (not shown) into which various memory cards can be inserted is exposed. The image data to be printed, stored on a memory card can be read into the scanner 10 through the card slot.

As shown in FIG. 1, the printer 30 has a paper feed tray 38, a paper ejection tray 39, etc. Print paper 40 is set on the paper feed tray 38. As the user operates the cross button 171, etc., of the scanner 10, when a print command, etc., is sent to the printer 30, the print paper 40 is fed from the paper feed tray 38 and print is executed. After the print, the print paper 40 is ejected onto the paper ejection tray 39.

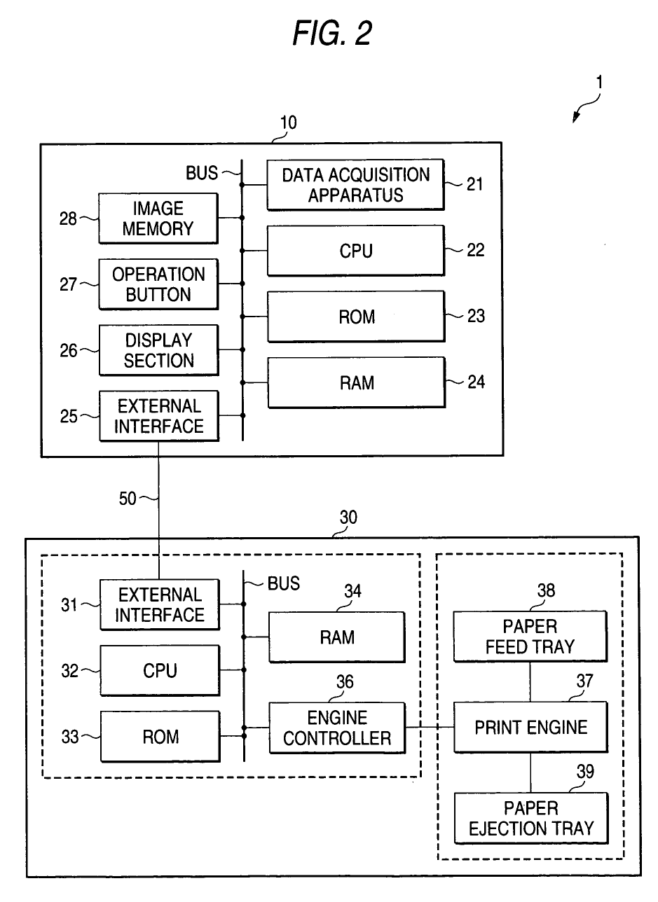

FIG. 2 is a block diagram to show the hardware configuration of the print system 1.

The scanner 10 includes hardware of a data acquisition section 21, a CPU 22, ROM 23, RAM 24, an external interface (I/F) 25, a display section 26, an operation button 27, image memory 28, etc. The hardware components of the data acquisition section 21, etc., are connected via a bus.

The data acquisition section 21 is means for acquiring the image data to be printed. The scan result of a film, etc., inserted through the holder insertion slot 18 and the image data stored on a memory card inserted through the card slot are input into the scanner 10 by the data acquisition section 21.

The CPU 22 reads a program stored in the ROM 23 whenever necessary and executes various types of processing. For example, the CPU 22 performs image processing of color conversion processing, halftone processing, etc., for the image data acquired in the data acquisition section 21.

The ROM 23 stores various programs executed by the CPU 22. The ROM 23 also stores the correspondence between printer setup information and print control sequence and printer setup information used temporarily if actual printer setup information is unknown, which will be hereinafter referred to as “temporary printer setup information.”

Although the printer setup information can be defined specifically in response to design, information of the ink type of ink set in the printer 30 (photo black, mat black) is adopted as the printer setup information in the embodiment.

The temporary printer setup information can also be defined in response to design; for example, it is considered that photo black for photo paper is preset as the temporary printer setup information to control the print operation assuming that high-quality print (print on photo paper) is performed if the actual printer setup information is unknown.

The print control sequence is a sequence containing processing of prescan, menus screen presentation, user entry acceptance, scan, image processing (image edit, color conversion, binarization, etc.,), print data generation, print data queuing, print data transmission, etc.

As for the menus screen presentation, for example, a menu screen for selecting the paper type (photo paper, photo mat paper, etc.,), the output size (A4, L format, roll paper, etc.,), and the print quality mode (“beautiful,” “high definition,” etc.,) can be considered. The print quality mode is information for determining the scan resolution, image processing parameter, print resolution, etc., together with the original size, the print size, etc. For example, in the “high definition” mode, the scan resolution may be set to 3200 dpi; in the “beautiful” mode, the scan resolution may be set to 1600 dpi.

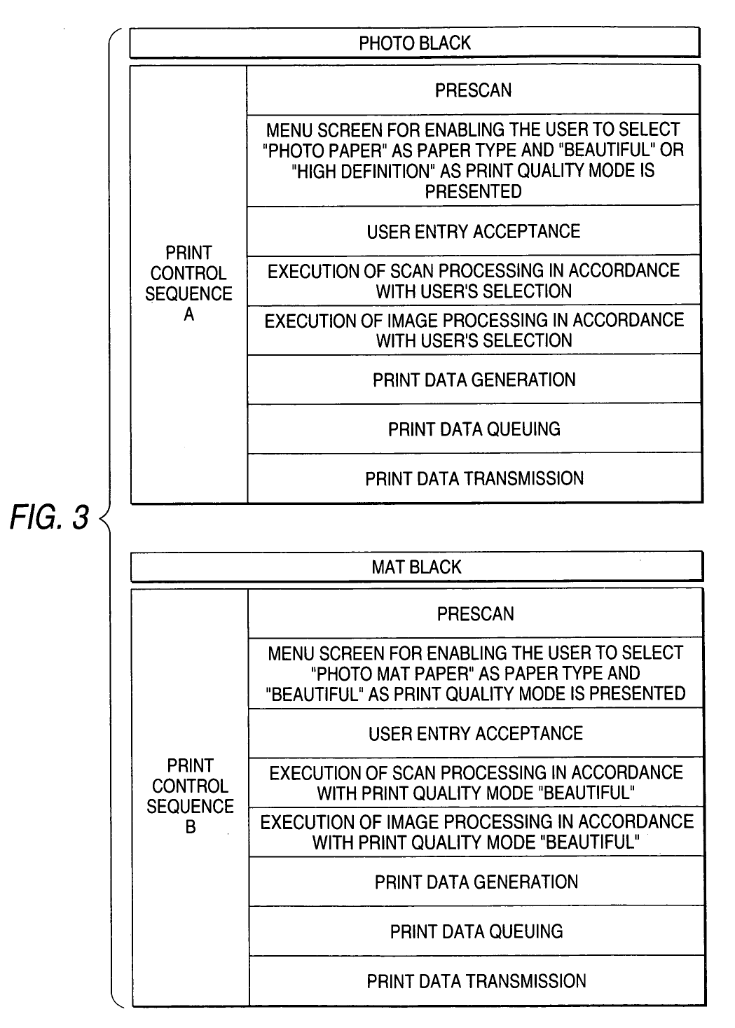

FIG. 3 shows an example of the correspondence between the printer setup information (ink type) and the print control sequence, stored in the ROM 23. In this example, print control sequence A corresponding to photo black contains presentation processing of a menu screen for enabling the user to select “photo paper” as the paper type and “beautiful” or “high definition” as the print quality mode. It also contains processing of scanning the print target and image processing for obtained image data in accordance with any mode of “beautiful” or “high definition” selected by the user. On the other hand, print control sequence B corresponding to mat black contains presentation processing of a menu screen for enabling the user to select “photo mat paper” as the paper type and “beautiful” as the print quality mode. It also contains processing of scanning the print target and image processing for obtained image data in accordance with the print quality mode “beautiful.”

Data being processed or after processed by the CPU 22 is stored in the RAM 24. The RAM 24 also serves as working memory of the CPU 22.

The external I/F 25 is connected to the printer 30 for converting the print data, etc., into a predetermined transmission format and outputting the data, etc., to the printer 30 and also converting the data output from the printer 30 into data that can be processed in the scanner 10 under the control of the CPU 22.

The display section 26 displays various menu screens on the liquid crystal panel 16 under the control of the CPU 22. The operation button 27 is a button for selecting an item in the menu screen displayed on the liquid crystal panel 16, etc., and corresponds to the cross button 171, the OK button 172, the selection buttons 173 in FIG. 1.

The image memory 28 is memory for expanding and storing the image data acquired in the data acquisition section 21. The CPU 22 performs various types of processing described above for the image data stored in the image memory 28 and generates print data.

Next, the configuration of the printer 30 will be discussed. As shown in FIG. 2, the printer 30 includes hardware of an external I/F 31, a CPU 32, ROM 33, RAM 34, an engine controller 36, a print engine 37, and the like. The external I/F 31, the CPU 32, the ROM 33, the RAM 34, and the engine controller 36 are connected via a bus.

The external I/F 31 accepts data of print data, etc., output from the scanner 10 in a predetermined transmission format and converts the data into data that can be processed in the printer 30 and also converts the data into a predetermined transmission format and outputs the data to the scanner 10 under the control of the CPU 32.

The CPU 32 reads a program stored in the ROM 33 whenever necessary and executes various types of processing for the print data.

The ROM 33 stores various programs executed by the CPU 32.

Data being processed or after processed by the CPU 32 is stored in the RAM 34. The RAM 34 also serves as working memory of the CPU 32.

The engine controller 36 is connected to the print engine 37 and causes the print engine 37 to execute the print operation according to a control instruction from the CPU 32.

The print engine 37 is made up of color (cyan, magenta, yellow, black, etc.,) ink cartridges, heads for ejecting color ink, a roller for moving the print paper 40, and the like. The sections operate based on a control signal from the engine controller 36, and an image is formed on the print paper 40 based on the print data acquired in the scanner 10 and the like.

The print engine 37 in the embodiment can cover different types of ink with respect to a predetermined color. For example, for black, either of the two types of ink cartridges of photo black for photo paper and mat black for photo mat paper can be selected and set. Any of different types of print paper (for example, photo paper, photo mat paper) can be selected and set corresponding to the ink type.

An outline of the operation of the described print system 1 will be discussed. First, a menu screen for inputting an image into the scanner 10 is displayed on the display section 26 as the user operates the operation button 27. As the user operates the operation button 27, the image data to be printed is input into the scanner 10 from the data acquisition section 21. The image data is expanded and stored in the image memory 28, for example. The above-described image processing is performed for the image data to generate print data, and the generated print data is output to the printer 30 together with a print command, etc., from the scanner 10. The CPU 32 of the printer 30 outputs a control signal for printing based on the print data, the command, etc., to the engine controller 36 for operating the print engine 37. Consequently, an image is formed on the print paper 40 by the print engine 37.

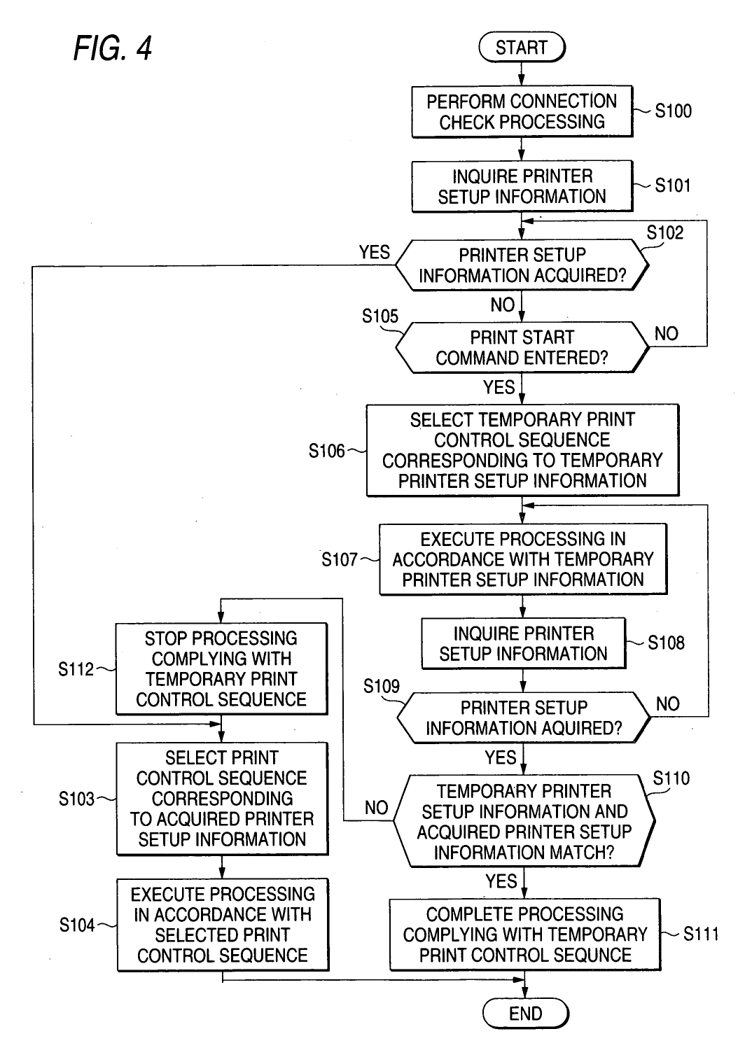

Print control processing of the scanner 10 will be discussed with reference to FIG. 4. Steps (containing partial steps given no reference numerals) can be executed with the order changed as desired or in parallel in the range in which a contradiction does not arise in the processing.

When the power is turned on (or the scanner 10 is reset), the scanner 10 (more strictly, the CPU 22 of the scanner 10) executes predetermined connection check processing with the printer 30 (S100). For example, if the scanner 10 and the printer 30 are connected based on USB (Universal Serial Bus) standard, the scanner 10 executes the connection check processing in compliance with the USE standard protocol.

Next, the scanner 10 inquires of the printer 30 whose connection is checked the printer setup information (S101).

Upon reception of the inquiry, the printer 30 acquires ink type information (for example, ink type ID) based on information of the ink cartridge, etc., set in the printer 30 and sends the information to the scanner 10 as the printer setup information.

However, when power is turned on (or the printer 30 is reset), the printer 30 in the embodiment executes connection check processing with the scanner 10 and also executes predetermined initialization processing (such as error check processing of ink cartridges, etc.,) and after completion of the initialization processing, sends the printer setup information to the scanner 10. Thus, if the printer 30 accepts the inquiry about the printer setup information from the scanner 10 before completion of the initialization processing, the printer 30 notifies the scanner 10 that the printer setup information is unknown.

Next, the scanner 10 determines whether or not the printer setup information of the printer 30 can be acquired based on the notification received from the printer 30 (S102).

If the printer setup information can be acquired, the scanner 10 selects the print control sequence corresponding to the acquired printer setup information (S103). For example, if the ink type is photo black, the print control sequence A shown in FIG. 3 is selected; if the ink type is mat black, the print control sequence B shown in FIG. 3 is selected.

The scanner 10 executes the processing sequence of prescan, menus screen presentation, user entry acceptance, scan, image processing (image edit, color conversion, binarization, etc.,), print data generation, print data queuing, print data transmission, etc., in accordance with the selected print control sequence (S104).

For example, in the menus screen presentation processing in the print control sequence A, “photo paper” is presented as it can be selected as print paper, and “high definition” or “beautiful” is presented as it can be selected as print quality. For example, in the menus screen presentation processing in the print control sequence B, “photo mat paper” is presented as it can be selected as print paper, and “beautiful” is presented as it can be selected as print quality.

On the other hand, if the printer setup information cannot be acquired (containing the case where notification does not come after the expiration of a given time), the scanner 10 determines whether or not a print start command is accepted from the user (S105).

If a print start command is not accepted, the scanner 10 returns to step S102; if a print start command is accepted, the scanner 10 selects the print control sequence corresponding to the temporary printer setup information as temporary print control sequence (S106). For example, if photo black for photo paper is set as the ink type in the temporary printer setup information, the print control sequence A shown in FIG. 3 is selected as the temporary print control sequence.

The scanner 10 executes the processing sequence of prescan, menus screen presentation, user entry acceptance, scan, image processing (image edit, color conversion, binarization, etc.,), print data generation, print data queuing, print data transmission, etc., in accordance with the selected temporary print control sequence (S107).

The scanner 10 executes continuation determination processing of the temporary print control sequence at a predetermined timing during execution of the processing complying with the temporary print control sequence (S108 to S112)

The point in time at which periodic or predetermined processing (scan processing, image processing, etc.,) is complete or the like is possible as the predetermined timing. In the flowchart of FIG. 4, the processing complying with the temporary print control sequence and the continuation determination processing are executed sequentially, but may be executed in parallel. However, if the processing complying with the temporary print control sequence proceeds to a predetermined timing (for example, print data generation start timing, etc.,) the scanner 10 once stops the processing and waits until whether or not the temporary print control sequence is continued is determined.

First, the scanner 10 inquires of the printer 30 the printer setup information (S108).

Next, the scanner 10 determines whether or not the printer setup information of the printer 30 can be acquired based on the notification received from the printer 30 (S109).

If the printer setup information cannot be acquired (containing the case where notification does not come after the expiration of a given time), the scanner 10 returns to S107 and advances the processing complying with the temporary print control sequence.

On the other hand, if the printer setup information can be acquired, the scanner 10 determines whether or not the temporary printer setup information and the acquired printer setup information match (S110).

If the temporary printer setup information and the acquired printer setup information match, the scanner 10 determines that the processing complying with the temporary print control sequence can be continued, and returns to S107 and completes the processing complying with the temporary print control sequence (S111). In this case, the determination result as to whether or not the processing can be continued is already obtained and therefore continuation determination processing is not executed.

On the other hand, if the temporary printer setup information and the acquired printer setup information do not match, the scanner 10 determines that the processing complying with the temporary print control sequence cannot be continued, and stops the processing (S112) and returns to S103 to select print control sequence based on the acquired printer setup information.

Thus, in the embodiment, the scanner 10 acquires the printer setup information from the printer 30 to which the scanner 10 is connected, and selects the print control sequence corresponding to the printer setup information, so that if the printer setup information is changed, the user need not enter the change in the scanner 10 and the burden on the entry of the user can be reduced.

If a print start command is accepted before the printer setup information is acquired, the processing is advanced in accordance with the temporary print control sequence selected based on the temporary printer setup information. Thus, if the actual printer setup information later acquired and the temporary printer setup information match, the print control processing can be started in advance without waiting for acquiring the printer setup information and consequently it is made possible to promptly start the print operation.

(Modifications)

The invention is not limited to the specific embodiment described above and various modifications can be made. For example, in the embodiment described above, the print control apparatus is described by taking the scanner 10 as an example, but the print control apparatus of the invention need not necessarily have the scanner function. In other words, the invention can also be applied to a print control apparatus for executing print control sequence (for example, print control sequence containing various types of processing such as menus screen presentation, user entry acceptance, image read, image processing (image edit, color conversion, binarization, etc.,), print data generation, print data queuing, and print data transmission) not containing scan processing (prescan, scan, scan resolution determination processing, etc.,).

In the embodiment described above, the ink type is adopted as the printer setup information and the print control sequence is selected based on the ink type, but the invention is not limited to the mode. For example, any other parameter, etc., can also be adopted as the printer setup information in place of or in addition to the ink type so that the print control sequence is selected based on them. The printer setup information need not necessarily be implemented as only information used to select print control sequence and may contain any other information used for the print operation.

In the embodiment described above, if the temporary printer setup information and the acquired printer setup information do not match, processing is started at menu screen presentation processing in accordance with the print control sequence corresponding to the acquired printer setup information, but the invention is not limited to the mode. For example, if some of the data provided by performing the processing complying with the temporary print control sequence can also be used in processing complying with the print control sequence corresponding to the acquired printer setup information, the data may be reused for executing the processing. For example, if the temporary print control sequence is A-B-C-D and the print control sequence corresponding to the acquired printer setup information is A-B′-C′-D, process A is common to both the sequences and thus the processing complying with the print control sequence corresponding to the acquired printer setup information can be started at process B′ using the result of the process A in the temporary print control sequence.

If the temporary printer setup information and the acquired printer setup information do not match, a message for prompting the user to change the printer parameter, etc., so as to fit to temporarily used printer setup information may be displayed on the display section 16 and when the user enters change completion, the temporary print control sequence may be continued.

1. A method of controlling a print control apparatus which selects a print control sequence in response to printer setup information acquired from a printer connected to the print control apparatus and executes the selected print control sequence, the method comprising:
if the print control apparatus accepts a print request before the printer setup information is acquired from the printer, selecting and executing the print control sequence corresponding to temporary printer setup information.

2. The method according to claim 1 further comprising:
acquiring the printer setup information from the printer before the corresponding print control sequence is completed; and
completing the print control sequence corresponding to the temporary printer setup information if the temporary printer setup information matches the printer setup information acquired from the printer.

3. The method according to claim 1 further comprising stopping the print control sequence corresponding to the temporary printer setup information if the temporary printer setup information does not matches the printer setup information acquired from the printer.

4. The method according to claim 3 further comprising executing a print control sequence corresponding to the printer setup information acquired from the printer if the temporary printer setup information does not match the printer setup information acquired from the printer.

5. The method according to claim 1 further comprising executing one of processing of executing a print control sequence corresponding to the printer setup information acquired from the printer and processing of promoting a user to change a printer parameter so as to fit to the temporary printer setup information if the temporary printer setup information does not match the printer setup information acquired from the printer.

6. A print control apparatus which selects a print control sequence in response to printer setup information acquired from a printer connected to the print control apparatus and executes the selected print control sequence, and selects and executes the print control sequence corresponding to temporary printer setup information if the print control apparatus accepts a print request before the printer setup information is acquired from the printer.

7. The print control apparatus according to claim 6, wherein
the printer setup information is acquired from the printer before the corresponding print control sequence is completed; and
the print control sequence corresponding to the temporary printer setup information is completed if the temporary printer setup information matches the printer setup information acquired from the printer.

8. The print control apparatus according to claim 6, wherein the print control sequence corresponding to the temporary printer setup information is stopped if the temporary printer setup information does not matches the printer setup information acquired from the printer.

9. The print control apparatus according to claim 6, wherein the printer setup information includes information of ink set in the printer.

10. The print control apparatus according to claim 6, wherein the print control apparatus comprises a scanner function and the print control sequence includes scan processing.

11. The print control apparatus according to claim 6, wherein the print control sequence includes at least any process of menus screen presentation, user entry acceptance, image read, image processing, print data generation, or print data transmission.

12. The print control apparatus according to claim 6, wherein one of processing of executing the print control sequence corresponding to the acquired printer setup information and processing of prompting a user to change a printer parameter so as to fit to the temporary printer setup information is executed if the temporary printer setup information does not match the printer setup information acquired from the printer.

13. The print control apparatus according to claim 6, wherein the print control apparatus includes a display unit that displays a screen showing an image processing information concerning the temporary printer setup information before acquiring the printer setup information from the printer, and an image processing unit that executes image processing using the image processing information concerning the temporary printer setup information when accepting a print start command which employs the image processing information concerning the temporary printer setup information.

14. A print system comprising:
a print control apparatus according to claim 6; and
a printer that executes printing based on a print data transmitted from the print control apparatus,
wherein the printer executes a predetermined initialization processing when the printer is turned on or the printer is reset, and sends the printer setup information after completing the initialization processing.

15. The print system according to claim 14, wherein the printer stores the printer setup information.
